(19) United States
(12) Patent Application Publication
(10) Pub. No.: US 2025/0299008 A1
(43) Pub. Date: Sep. 25, 2025

(54) INFORMATION PROCESSING SYSTEM, NON-TRANSITORY COMPUTER READABLE MEDIUM STORING PROGRAM, AND INFORMATION PROCESSING METHOD

(71) Applicant: FUJIFILM BUSINESS INNOVATION CORP., Tokyo (JP)

(72) Inventors: Takashi KAMIYAMA, Kanagawa (JP); Miyu Fujii, Kanagawa (JP)

(73) Assignee: FUJIFILM BUSINESS INNOVATION CORP., Tokyo (JP)

(21) Appl. No.: 18/808,649

(22) Filed: Aug. 19, 2024

(30) Foreign Application Priority Data
Mar. 25, 2024 (JP) 2024-048718

(51) Int. Cl. G06K 15/02

(52) U.S. Cl. CPC G06K 15/1889; G06K 15/1836; G06K 15/1878

(57) ABSTRACT

An information processing system includes a processor configured to: in response to an automatic changing process performed in accordance with a preset rule on pixel data indicating a pixel in an overlapping portion of raster data created from a print job for forming an image by superposing, one on top of another, an object drawn with a normal toner and an object drawn with a special toner different from the normal toner, display a value of attribute information that is subjected to the changing process in a format different from a format of a value of the attribute information that is not subjected to the changing process on a preview screen showing the raster data.

### CROSS-REFERENCE TO RELATED APPLICATIONS

This application is based on and claims priority under 35 USC 119 from Japanese Patent Application No. 2024-048718 filed Mar. 25, 2024.

### BACKGROUND

### (i) Technical Field

The present disclosure relates to an information processing system, a non-transitory computer readable medium storing a program, and an information processing method.

### (ii) Related Art

Japanese Unexamined Patent Application Publication No. 2009-130705 describes a document processing system including a special-color object detector that detects an object in a special color in electronic document data handled by a computer system, a special-color drawing attribute discriminator that discriminates the object attribute between partial coating and full coating, and a preview display controller that switches display methods based on the special-color drawing attribute when determination is made that the object attribute is coating.

### SUMMARY

Aspects of non-limiting embodiments of the present disclosure relate to the following perspective. In response to an automatic changing process on pixel data in an overlapping portion in raster data created from a print job for forming an image by superposing an object drawn with a normal toner and an object drawn with a special toner one on top of the other, a user is allowed to recognize that the changing process has been performed.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system comprising a processor configured to: in response to an automatic changing process performed in accordance with a preset rule on pixel data indicating a pixel in an overlapping portion of raster data created from a print job for forming an image by superposing, one on top of another, an object drawn with a normal toner and an object drawn with a special toner different from the normal toner, display a value of attribute information that is subjected to the changing process in a format different from a format of a value of the attribute information that is not subjected to the changing process on a preview screen showing the raster data.

### BRIEF DESCRIPTION OF THE DRAWINGS

An exemplary embodiment of the present disclosure will be described in detail based on the following figures, wherein:

FIG. 1 illustrates an overall configuration of an information processing system according to an exemplary embodiment;

FIG. 2 is a control block diagram of the hardware configuration of an operation terminal and a production printer of the information processing system;

FIG. 3 is a functional block diagram of the operation terminal;

FIG. 4A illustrates objects in an overlapping portion between normal toner data and special toner data;

FIG. 4B illustrates pieces of attribute information of the objects;

FIG. 5A illustrates the objects when the normal toner data and the special toner data are rasterized;

FIG. 5B illustrates the pieces of attribute information of the objects;

FIG. 6A illustrates the objects after total amount limitation on toner data in the overlapping portion between the normal toner data and the special toner data;

FIG. 6B illustrates the pieces of attribute information of the objects;

FIG. 7 illustrates a preview image showing image data subjected to a density changing process;

FIG. 8 illustrates a preview image showing image data subjected to a hiding process;

FIG. 9 is a flowchart illustrating a process to be performed by a CPU of the operation terminal;

FIG. 10 is a flowchart illustrating a process to be performed by the CPU of the operation terminal;

FIG. 11 illustrates a preview image of a modification;

FIG. 12 illustrates a preview image when a color adjustment process is performed;

FIG. 13 illustrates a preview image showing image data subjected to the hiding process;

FIG. 14 illustrates a preview image when the color adjustment process is performed; and

FIG. 15 is a flowchart illustrating a process to be performed by the CPU of the operation terminal in the modification.

### DETAILED DESCRIPTION

An exemplary embodiment of the present disclosure is described in detail with reference to the accompanying drawings.

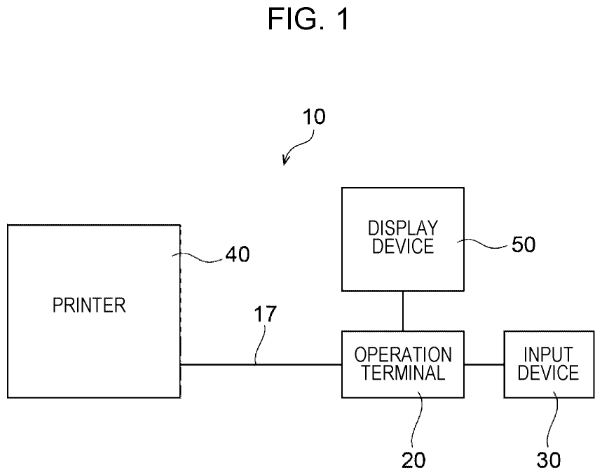

As illustrated in FIG. 1, an information processing system 10 (hereinafter referred to as “system 10”) of this exemplary embodiment includes an operation terminal 20, an input device 30, a production printer 40 (hereinafter referred to as “printer 40”), and a display device 50. In this exemplary embodiment, the operation terminal 20 is a personal computer, and the input device 30 includes a keyboard and a mouse electrically connected to the operation terminal 20. The operation terminal 20 and the printer 40 are connected to communicate with each other via a wired or wireless communication network 17 such as the Internet or a local area network (LAN). The display device 50 is electrically connected to the operation terminal 20.

The operation terminal 20 is described in detail.

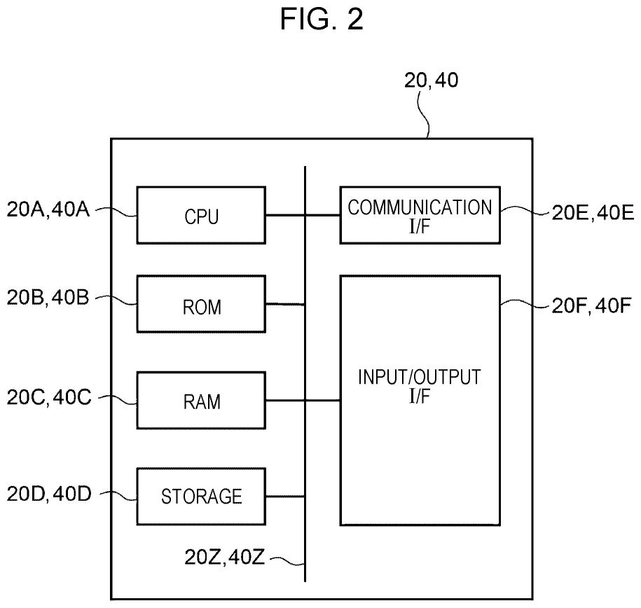

As illustrated in FIG. 2, the operation terminal 20 includes a central processing unit (CPU: processor) 20A, a read only memory (ROM) 20B, a random access memory (RAM) 20C, a storage 20D, a communication interface (I/F) 20E, and an input/output I/F 20F as hardware components. The CPU 20A, the ROM 20B, the RAM 20C, the storage 20D, the communication I/F 20E, and the input/output I/F 20F are connected to communicate with each other via a bus 20Z.

The CPU 20A is a central processing unit that executes various programs and controls various parts. The CPU 20A reads a program from the ROM 20B or the storage 20D, and executes the program using the RAM 20C as a working area. The CPU 20A controls various components and performs various types of arithmetic processing based on the programs recorded in the ROM 20B or the storage 20D.

The ROM 20B stores various programs and various types of data. The RAM 20C temporarily stores programs or data as a working area. The storage 20D is a storage device such as a hard disk drive (HDD) or a solid state drive (SSD), and stores various programs and various types of data. The communication I/F 20E is an interface for wired or wireless communication with other devices.

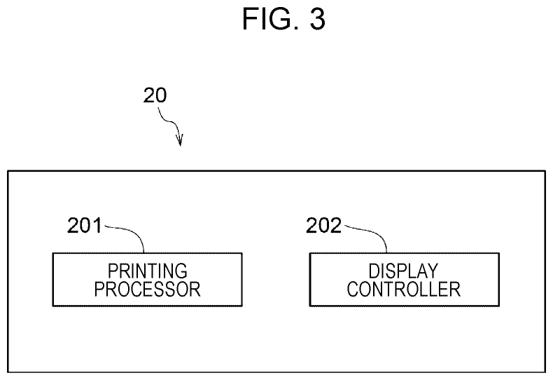

FIG. 3 is a block diagram of an example of the functional configuration of the operation terminal 20. The operation terminal 20 includes a printing processor 201 and a display controller 202 as functional components. The printing processor 201 and the display controller 202 are implemented by the CPU 20A reading and executing a program stored in the ROM 20B.

The printing processor 201 has a function of generating a predetermined print job based on a print instruction input by an operator to the operation terminal 20 using the input device 30, and transmitting the generated print job to the printer 40. For example, when a print instruction for printing of picture data (image data) recorded in the storage 20D is input to the operation terminal 20 using the input device 30, the printing processor 201 generates a print job indicating printing of the picture data, and transmits the print job to the printer 40.

The printing processor 201 generates image data based on the print job. An image processing function of the printing processor 201 is described in detail later.

The display controller 202 has a function of controlling the display device 50 to display various images. For example, when the printing processor 201 generates image data PD subjected to a density changing process described later, the display controller 202 causes the display device 50 to display a preview screen PV described later.

The printer 40 is described.

As illustrated in FIG. 2, the printer 40 includes a CPU 40A, a ROM 40B, a RAM 40C, a storage 40D, a communication I/F 40E, an input/output I/F 40F, and a bus 40Z as hardware components. The CPU 40A, the ROM 40B, the RAM 40C, the storage 40D, the communication I/F 40E, the input/output I/F 40F, and the bus 40Z have the same functions as the CPU 20A, the ROM 20B, the RAM 20C, the storage 20D, the communication I/F 20E, the input/output I/F 20F, and the bus 20Z, respectively.

The printer 40 is an image forming apparatus storing normal toners including a cyan (C) toner, a magenta (M) toner, a yellow (Y) toner, and a black (K) toner, and special toners including a transparent toner, a gold toner, and a silver toner.

The image processing function of the printing processor 201 of the operation terminal 20 is described in detail. When the print job generated by the operation terminal 20 is a command for printing with the normal toners and the special toners, the printing processor 201 generates image data using normal toner data and special toner data. When this print job is received from the operation terminal 20, the printer 40 prints an image based on the image data on print paper (recording medium) with the normal toners and the special toners.

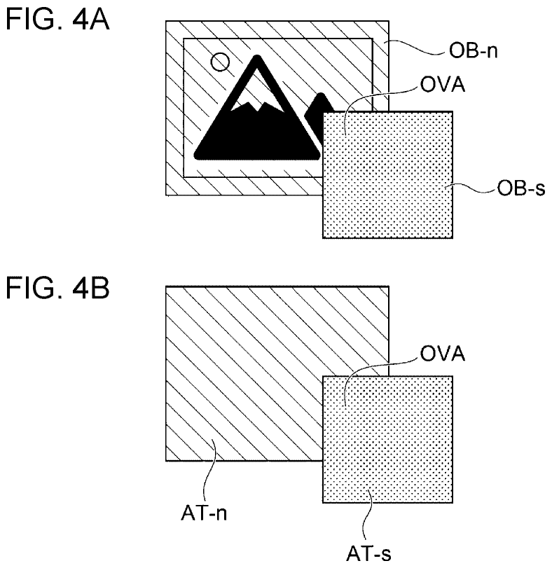

When the print job generated by the operation terminal 20 is, as illustrated in FIG. 4A, a command to form an image by superposing part of an object OB-n drawn with the normal toners and part of an object OB-s drawn with the special toners one on top of the other, the printing processor 201 performs a rasterization process so that special toner data is laid over (on the foreside of) part of normal toner data. In the following description, this print job is referred to as “special print job.” As illustrated in FIG. 4B, the object OB-n includes normal toner attribute information AT-n, and the object OB-s includes special toner attribute information AT-s. The attribute information includes, for example, information indicating text, lines, an image, coating, and shading.

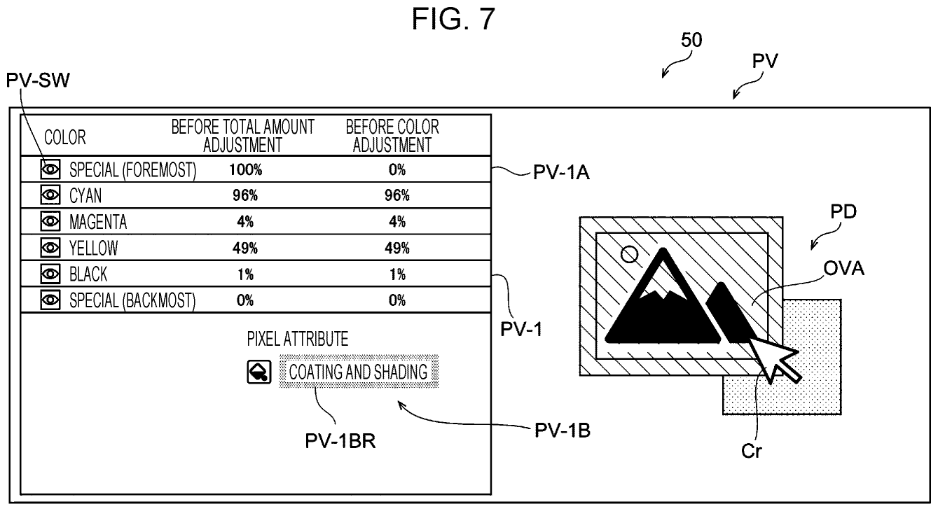

It is assumed that, when the object OB-n and the object OB-s illustrated in FIG. 4A are rasterized, the total amount of toners on each piece of pixel data in an overlapping portion OVA between the object OB-n and the object OB-s is larger than a predetermined threshold. In this case, the printing processor 201 limits the total amount of the toners on each piece of pixel data in the overlapping portion OVA as appropriate. For example, when the total amount (sum) of the cyan, magenta, yellow, black, and special toners on predetermined pixel data in the overlapping portion OVA is larger than a threshold of 150% as illustrated in FIG. 7, the printing processor 201 performs a process of changing the amount (density) of the special toner on the pixel data to 0%. That is, the amounts of the cyan, magenta, yellow, black, and special toners are changed from values in the “Before Total Amount Adjustment” section to values in the “Before Color Adjustment” section in FIG. 7. More specifically, the amount of the special toner is changed alone.

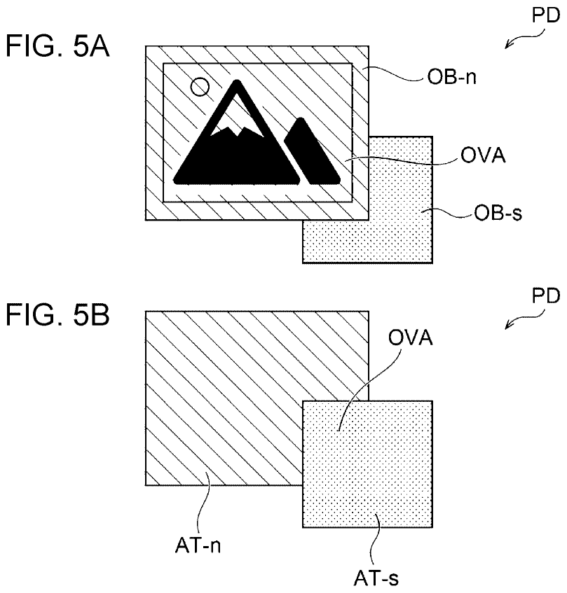

As illustrated in FIG. 5A, the printing processor 201 changes the image data so that the object OB-n is laid over part of the object OB-s in the overlapping portion OVA. That is, the density of the special toner data on each piece of pixel data in the overlapping portion OVA of the image data in FIG. 5A is 0%. As illustrated in FIG. 5B, the object OB-n includes the normal toner attribute information AT-n and the object OB-s includes the special toner attribute information AT-s also in this case. Therefore, each piece of pixel data in the overlapping portion OVA includes the attribute information AT-n and the special toner attribute information AT-s as the attribute information. The image data (raster data) in FIGS. 5A and 5B is referred to as “image data PD subjected to density changing process.”

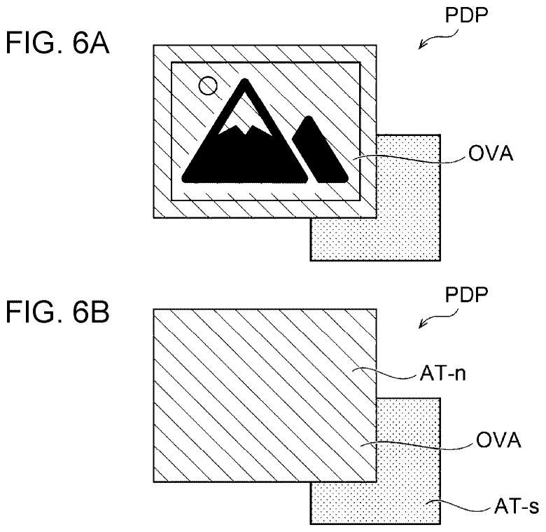

FIG. 6A illustrates print image data PDP obtained when the printing processor 201 performs predetermined image processing on the image data PD subjected to the density changing process in FIGS. 5A and 5B. As described above, the pixel data in the overlapping portion OVA of the image data on the terminal apparatus 20 includes the two pieces of attribute information AT-n and AT-s. When the print job is actually transmitted to the printer 40 and one piece of pixel data includes the plurality of pieces of attribute information, the printing is not performed. Therefore, when transmitting the special print job to the printer 40, the printing processor 201 generates the special print job including information indicating that the special toner attribute information AT-s in the overlapping portion OVA of the image data PD subjected to the density changing process in FIGS. 5A and 5B is not used. Alternatively, the printing processor 201 generates the print image data PDP in FIGS. 6A and 6B by deleting the special toner attribute information AT-s in the overlapping portion OVA of the image data PD subjected to the density changing process in FIGS. 5A and 5B from the special print job and leaving the normal toner attribute information AT-n. Therefore, each piece of pixel data in the overlapping portion OVA of the print image data PDP in FIG. 6B includes the normal toner attribute information AT-n alone.

When the operation terminal 20 generates the image data PD subjected to the density changing process, the display controller 202 of the operation terminal 20 controls the display device 50 to display a preview screen PV illustrated in FIG. 7. The right half of the preview screen PV displays the image data PD subjected to the density changing process. The left half of the preview screen PV is an information display field PV-1. The upper half of the information display field PV-1 is a toner information display field PV-1A that displays the amounts of the cyan, magenta, yellow, black, and special toners in the pixel data at a point indicated by a cursor Cr moved on the image data PD subjected to the density changing process using the mouse. The toner information display field PV-1A displays an actively selected layer. For example, FIG. 7 illustrates “eye” marks for the cyan, magenta, yellow, black, and special toners, and a layer represented using the cyan, magenta, yellow, black, and special toners is actively selected. In the toner information display field PV-1A, the amounts of the toners in the “Before Total Amount Adjustment” section are the amounts of the toners in the state illustrated in FIGS. 4A and 4B, and the amounts of the toners in the “Before Color Adjustment” section are the amounts of the toners in the state illustrated in FIGS. 5A and 5B. The lower half of the information display field PV-1 is an attribute information display field PV-1B that displays information on an attribute (value of attribute information) in the pixel data at the point indicated by the cursor Cr moved on the image data PD subjected to the density changing process using the mouse. When the cursor Cr selects the overlapping portion OVA, the attribute information display field PV-1B displays an attribute based on the attribute information AT-s of the object OB-s (special toner) in the foremost layer of the overlapping portion OVA. In the example illustrated in FIG. 7, the attribute in the pixel data at the point indicated by the cursor Cr is “Coating and Shading.” When the cursor Cr selects the overlapping portion OVA, the attribute information display field PV-1B displays a red rectangular display frame PV-1BR. That is, the attribute information display field PV-1B highlights the attribute information. The highlight of the attribute information is not limited to the rectangular frame, and may be any format such as text shading or frame blinking that discriminates from normal display. The red color of the highlight is also an example, and the color may be any color that discriminates from normal display.

When the cursor Cr is placed at a point (other portion) other than the overlapping portion OVA of the image data PD subjected to the density changing process, the attribute information display field PV-1B does not display the display frame PV-1BR. That is, the attribute information display field PV-1B normally displays the attribute information. That is, the attribute information display field PV-1B displays the attribute information in different formats when the cursor Cr is placed on the overlapping portion OVA of the image data PD subjected to the density changing process and when the cursor Cr is placed on any other portion. The normal display format may be such a format that the rectangular frame etc. is not displayed or the color of the frame is the same as that of the background of text.

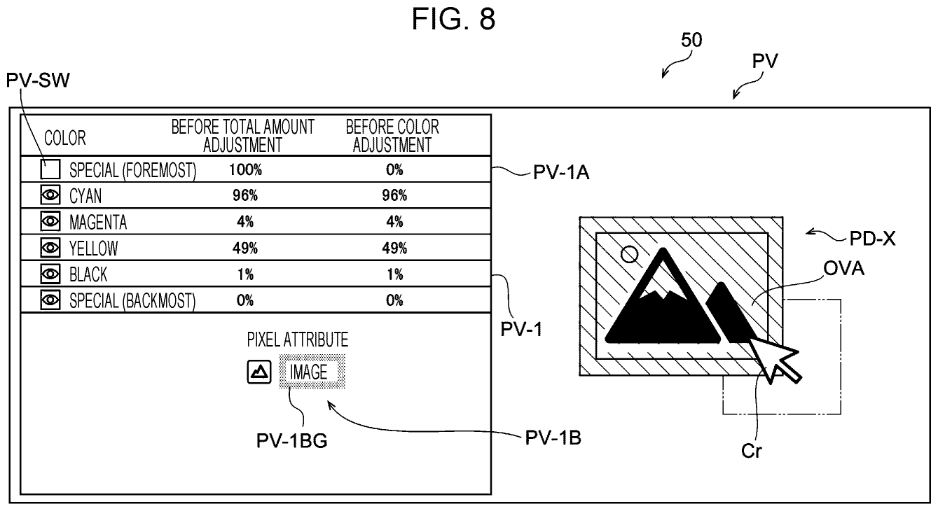

When a user performs a predetermined hiding operation using the input device 30 with the cursor Cr selecting a display switching image PV-SW in the information display field PV-1 of the preview screen PV, the preview screen PV displayed on the display device 50 is switched to the state in FIG. 8. The right half of the preview screen PV displays image data PD-X subjected to a hiding process in place of the image data PD subjected to the density changing process. The image data PD-X subjected to the hiding process is obtained in such a manner that the object OB-s (special toner) in the image data PD subjected to the density changing process is hidden. That is, the attribute information in the overlapping portion OVA of the image data PD-X subjected to the hiding process (attribute information AT-n) is the same as the attribute information in the overlapping portion OVA of the print image data PDP (attribute information AT-n). In the example illustrated in FIG. 8, the attribute in the pixel data at the point indicated by the cursor Cr is “Image.” When the cursor Cr selects the overlapping portion OVA, the attribute information display field PV-1B displays a green rectangular display frame PV-1BG. That is, the attribute information display field PV-1B highlights the attribute information. The highlight of the attribute information is not limited to the rectangular frame, and may be any format such as text shading or frame blinking that discriminates from normal display. The green color of the highlight is also an example, and the color may be any color that discriminates from normal display. The highlight level in the attribute information display field PV-1B in FIG. 8 may be lower than that in the attribute information display field PV-1B in FIG. 7. The attribute in the overlapping portion OVA in the actual printing is the attribute illustrated in FIG. 8 but is not the attribute illustrated in FIG. 7. For example, the highlight level may be high in a warm color and low in a cold color. Therefore, the color of the highlight may be red in FIG. 7 and green in FIG. 8. Alternatively, shades of color may be used so that the color of the highlight is dark in FIG. 7 and light in FIG. 8.

When the cursor Cr is placed at a point other than the overlapping portion OVA of the image data PD-X subjected to the hiding process, the attribute information display field PV-1B does not display the display frame PV-1BG. That is, the attribute information display field PV-1B normally displays the attribute information. That is, the attribute information display field PV-1B displays the attribute information in different formats when the cursor Cr is placed on the overlapping portion OVA of the image data PD-X subjected to the hiding process and when the cursor Cr is placed on any other portion. The normal display format may be such a format that the rectangular frame etc. is not displayed or the color of the frame is the same as that of the background of text.

When the user performs a predetermined display operation using the input device 30 with the cursor Cr placed on the display switching image PV-SW on the preview screen PV in FIG. 8, the preview screen PV is switched to the state in FIG. 7.

When the operation terminal 20 transmits the special print job to the printer 40, the printer 40 prints an image based on the print image data PDP on print paper with the normal toners and the special toners. In other words, the printer 40 does not print an image based on the image data PD subjected to the density changing process on print paper. Therefore, the user of the system 10 acquires the print paper alone with the image printed based on the print image data PDP. Thus, the overlapping portion OVA of the image data PD-X subjected to the hiding process in the preview screen PV displayed on the display device 50 accurately represents the overlapping portion OVA of the image on the print paper to be acquired by the user. In other words, the overlapping portion OVA of the image data PD subjected to the density changing process that is displayed on the display device 50 slightly deviates from the overlapping portion OVA of the image on the print paper to be acquired by the user.

The operation of the system 10 having the above configuration is described.

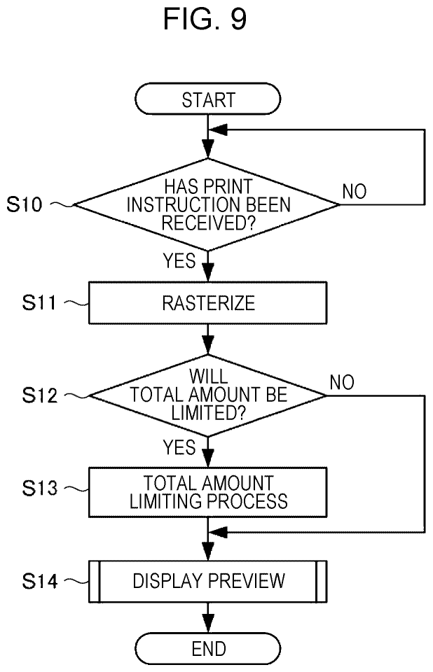

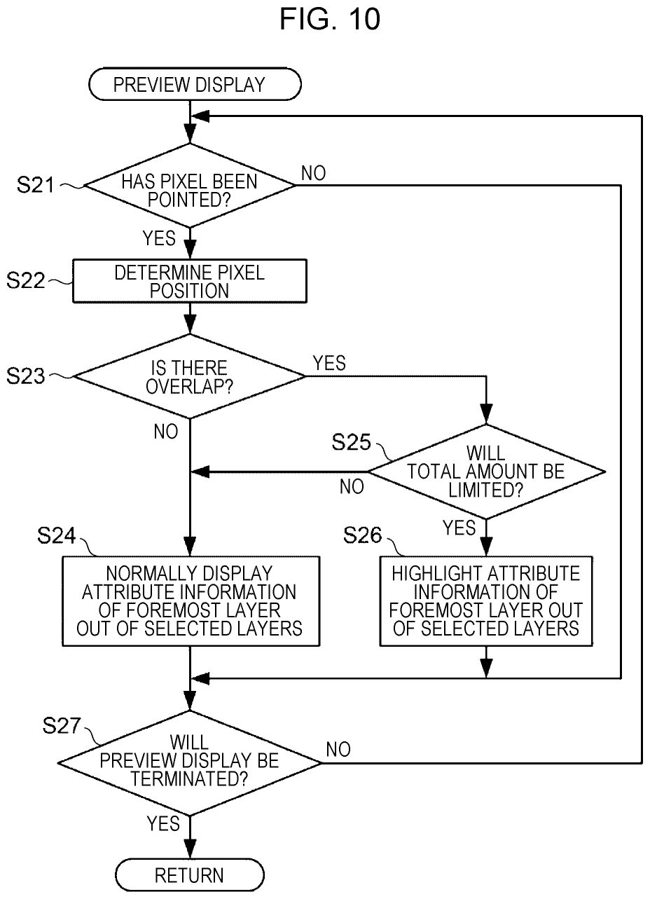

The CPU 20A of the operation terminal 20 repeats processes in the flowcharts of FIGS. 9 and 10 in every calculation cycle.

In Step S10 (“Step” is omitted hereinafter) in FIG. 9, the CPU 20A determines whether a print instruction is received from the input device 30.

When the determination result is “YES” in S10, the CPU 20A proceeds to S11, and rasterizes data based on the print instruction.

When the process in S11 is finished, the CPU 20A proceeds to S12, and determines whether the total amount (sum) of the cyan, magenta, yellow, black, and special toners on predetermined pixel data is larger than the threshold.

When the determination result is “YES” in S12, the CPU 20A proceeds to S13, and changes the density (value of attribute information) of the special toner data in the pixel data exceeding the threshold to 0%.

When the process in S13 is finished, the CPU 20A proceeds to S14. That is, the CPU 20A proceeds to S21 in FIG. 10, and determines whether a pointing process is performed such that the cursor Cr is placed at a predetermined point in the image data PD subjected to the density changing process in FIG. 7 or the image data PD-X subjected to the hiding process in FIG. 8.

When the determination result is “YES” in S21, the CPU 20A proceeds to S22, and determines the position of a pointed pixel. That is, the CPU 20A identifies pointed pixel data.

When the process in S22 is finished, the CPU 20A proceeds to S23, and determines whether the pointed position is in the overlapping portion OVA.

When the determination result is “NO” in S23, the CPU 20A proceeds to S24, and normally displays the attribute information of the foremost layer out of the layers of the pointed pixel data.

When the determination result is “YES” in S23, the CPU 20A proceeds to S25, and performs the same process as in S12.

When the determination result is “YES” in S25, the CPU 20A proceeds to S26, and highlights the attribute information of the foremost layer out of the layers of the pointed pixel data. For example, when the pointing process is performed in the overlapping portion OVA of the image data PD-X subjected to the hiding process in FIG. 8, the attribute information display field PV-1B displays the display frame PV-1BG.

When the determination result is “NO” in S21 or when the process in S24 or S26 is finished, the CPU 20A proceeds to S27, and determines whether a preview termination instruction is received from the input device 30.

When the determination result is “YES” in S27, the CPU 20A temporarily terminates the processes in the flowcharts.

As described above, in response to the automatic changing process (density process on special toner) on the pixel data in the overlapping portion OVA, the system 10 of this exemplary embodiment displays the value of the attribute information in the overlapping portion OVA and the value of the attribute information in the other portion in different formats.

As described above, in response to reception of the special print job from the operation terminal 20, the printer 40 prints an image based on the print image data PDP on print paper. The overlapping portion OVA of the image data PD-X subjected to the hiding process in the preview screen PV accurately represents the overlapping portion OVA of the image on the print paper to be acquired by the user.

The system 10 uses the display switching image PV-SW on the preview screen PV to cause the attribute information display field PV-1B to switch the display of the attribute information AT-s (first value) indicating the attribute of the object drawn with the special toner and the attribute information AT-n (second value) indicating the attribute of the object drawn with the normal toners as the attribute information in the overlapping portion OVA.

Although the system 10 and the program according to this exemplary embodiment have been described above with reference to the drawings, the system 10 and the program according to this exemplary embodiment are not limited to those in the illustration, and the design may be modified as appropriate without departing from the gist disclosed herein.

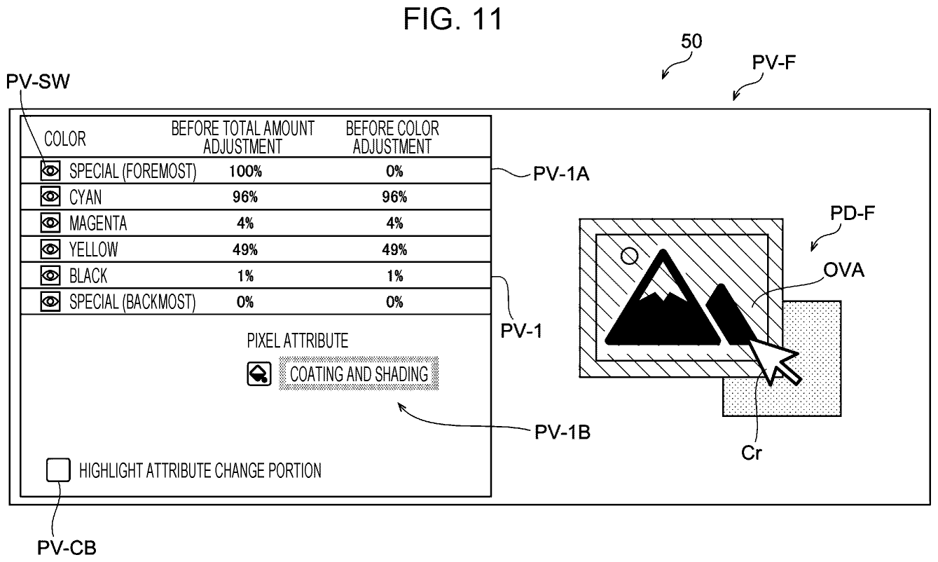

For example, a modification illustrated in FIGS. 11 to 15 may be employed.

In this modification, when the operation terminal 20 generates the image data PD subjected to the density changing process, the display device 50 displays a preview screen PV-F as illustrated in FIG. 11. The preview screen PV-F is basically the same as the preview screen PV of the exemplary embodiment, but is different in that the information display field PV-1 includes a checkbox image PV-CB.

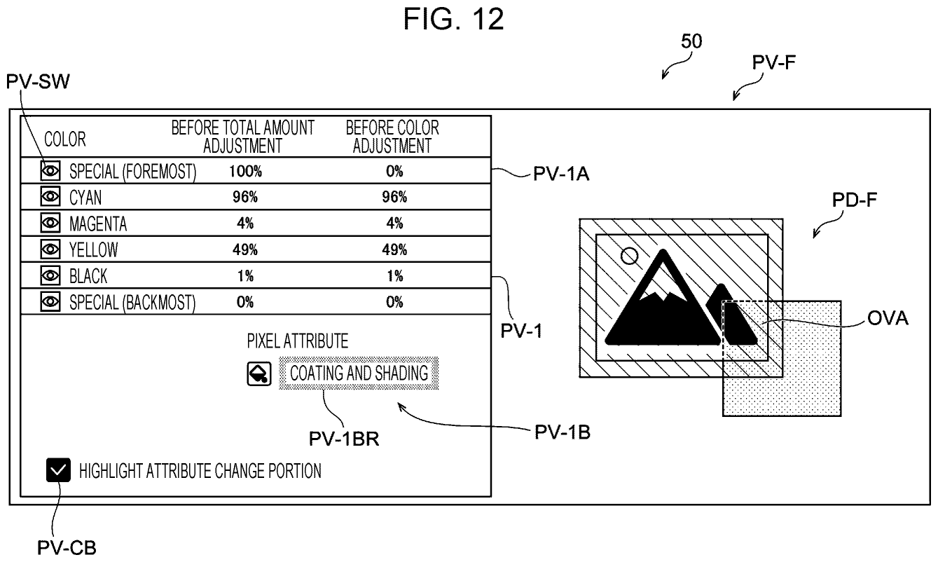

When the user performs a predetermined operation using the input device 30 with the cursor Cr placed on the checkbox image PV-CB, the preview screen PV-F is switched to the state in FIG. 12. The preview screen PV-F illustrated in FIG. 12 displays image data PD-F subjected to the density changing process corresponding to the image data PD subjected to the density changing process. The area corresponding to the overlapping portion OVA of the image data PD-F subjected to the density changing process is displayed in red. That is, the area corresponding to the overlapping portion OVA is highlighted. The red color of the highlight is an example, and the color may be any color that discriminates from normal display. If there is no change except for the overlapping portion OVA, the overlapping portion OVA is highlighted by coloring the overlapping portion OVA. Alternatively, the overlapping portion OVA may relatively be highlighted by graying out the portion other than the overlapping portion OVA and displaying the overlapping portion OVA as it is without grayout.

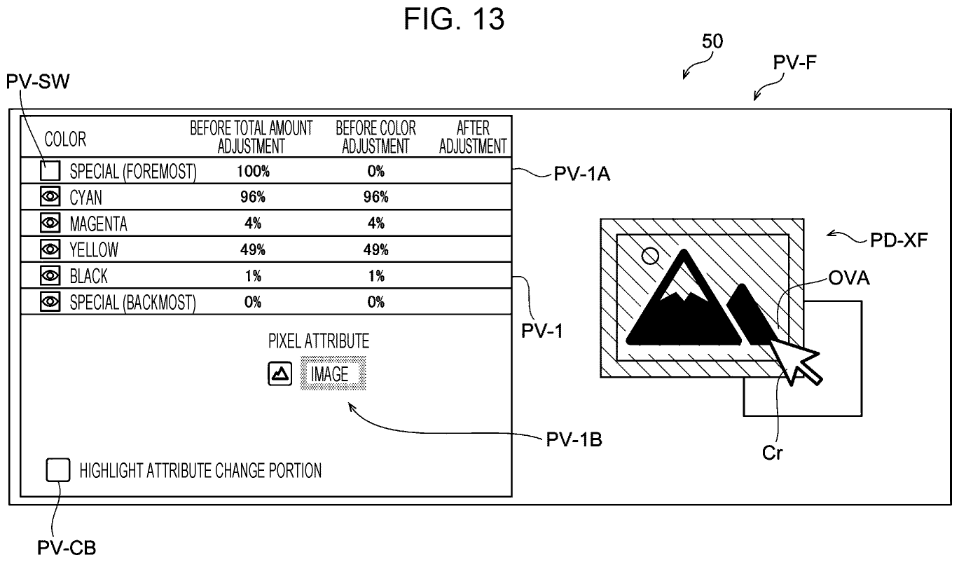

In this modification, when the hiding operation is performed on the display switching image PV-SW, the preview screen PV-F in FIG. 11 is changed to the state in FIG. 13.

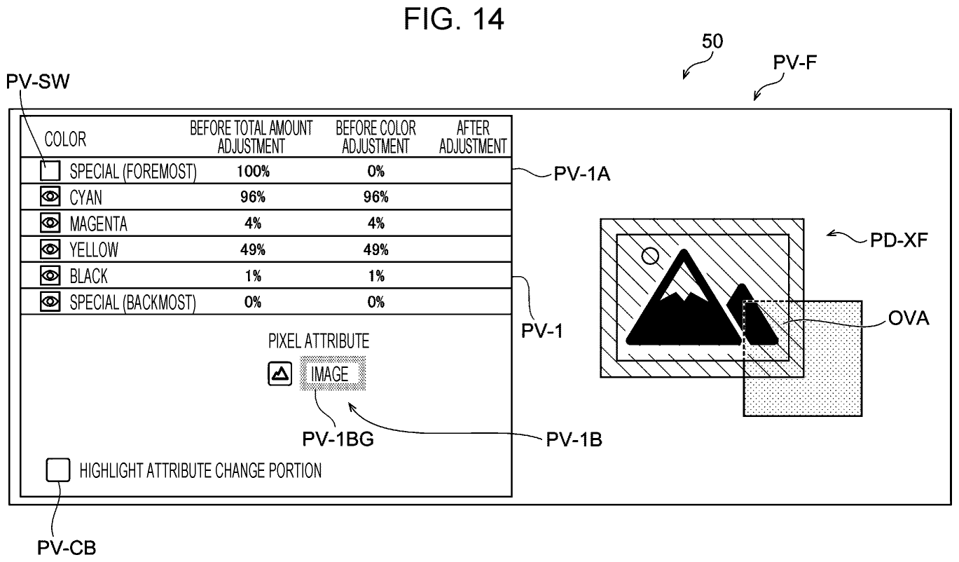

When the user performs the predetermined operation using the input device 30 with the cursor Cr placed on the checkbox image PV-CB, the preview screen PV-F is switched from the state in FIG. 13 to the state in FIG. 14. The preview screen PV-F illustrated in FIG. 14 displays image data PD-XF subjected to the hiding process corresponding to the image data PD-X subjected to the hiding process. The area corresponding to the overlapping portion OVA of the image data PD-XF subjected to the hiding process is displayed in green. That is, the area corresponding to the overlapping portion OVA is highlighted. The green color of the highlight is an example, and the color may be any color that discriminates from normal display. If there is no change except for the overlapping portion OVA, the overlapping portion OVA is highlighted by coloring the overlapping portion OVA. Alternatively, the overlapping portion OVA may relatively be highlighted by graying out the portion other than the overlapping portion OVA and displaying the overlapping portion OVA as it is without grayout. The highlight level of the overlapping portion OVA in FIG. 14 may be lower than that of the overlapping portion OVA in FIG. 12. For example, the highlight level may be high in a warm color and low in a cold color. Therefore, the color of the highlight may be red in FIG. 12 and green in FIG. 14. Alternatively, shades of color may be used so that the color of the highlight is dark in FIG. 12 and light in FIG. 14. Alternatively, the color of the highlight in FIG. 12 may be the same as that in FIG. 7, and the color of the highlight in FIG. 14 may be the same as that in FIG. 8.

The operation of the system 10 of the modification having the above configuration is described.

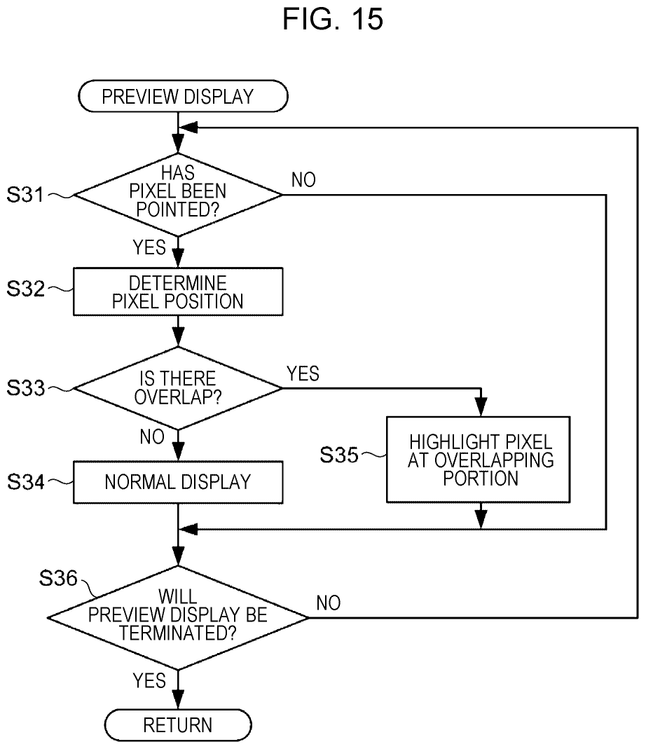

When the process in S13 in FIG. 9 is finished, the CPU 20A of the operation terminal 20 proceeds to S31 in FIG. 15. S31, S32, S33, and S36 in FIG. 15 are the same as S21, S22, S23, and S27 in FIG. 10.

When the determination result is “YES” in S33, the CPU 20A proceeds to S35, and highlights the overlapping portion OVA. For example, the overlapping portion OVA of the image data PD-XF subjected to the hiding process in FIG. 14 is highlighted in green.

When the determination result is “YES” in S36, the CPU 20A temporarily terminates the process in the flowchart.

In the modification illustrated in FIGS. 11 to 15, the colors of the overlapping portions OVA of the image data PD-F subjected to the density changing process and the image data PD-XF subjected to the hiding process may be selected from among a large number of colors.

The printer 40 may have the function of the printing processor 201 (image processing function). For example, when the operation terminal 20 transmits a print job to the printer 40, the printer 40 generates the image data PD subjected to the density changing process, the print image data PDP, etc. using the image processing function.

In the exemplary embodiment and each modification, the operation terminal 20 may be a smartphone or a tablet computer instead of the personal computer.

The overlapping portion OVA of the image data PD-F subjected to the density changing process in FIG. 12 may have a special pattern (e.g., polka-dot pattern) instead of the red color. The overlapping portion OVA of the image data PD-XF subjected to the hiding process in FIG. 14 may have a special pattern (e.g., hatching) instead of the green color.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing system comprising:
a processor configured to:
   in response to an automatic changing process performed in accordance with a preset rule on pixel data indicating a pixel in an overlapping portion of raster data created from a print job for forming an image by superposing, one on top of another, an object drawn with a normal toner and an object drawn with a special toner different from the normal toner, display a value of attribute information that is subjected to the changing process in a format different from a format of a value of the attribute information that is not subjected to the changing process on a preview screen showing the raster data.
(((2)))

The information processing system according to (((1))), wherein the value of the attribute information that is subjected to the changing process comprises a first value and a second value.
(((3)))

The information processing system according to (((2))), wherein:
the changing process is a process of changing a density of the special toner in the overlapping portion to zero;
the first value is a value indicating an attribute of the object drawn with the special toner; and
the second value is a value indicating an attribute of the object drawn with the normal toner.
(((4)))

The information processing system according to any one of (((1))) to (((3))), wherein the processor is configured to:
receive switching as to whether to display or hide the object drawn with the special toner on the preview screen;
when displaying the object drawn with the special toner, highlight a value indicating an attribute of the object drawn with the special toner as the value of the attribute information that is subjected to the changing process; and
when hiding the object drawn with the special toner, highlight a value indicating an attribute of the object drawn with the normal toner as the value of the attribute information that is subjected to the changing process.
(((5)))

The information processing system according to any one of (((1))) to (((4))), wherein the processor is configured to, in response to the changing process performed on the pixel data in the overlapping portion, display a range of the overlapping portion between the object drawn with the normal toner and the object drawn with the special toner on the preview screen so that the range of the overlapping portion is discriminable from another portion.
(((6)))

The information processing system according to (((5))), wherein the processor is configured to display the range of the overlapping portion by colorization of the range of the overlapping portion so that the range of the overlapping portion is discriminable from the other portion.
(((7)))

The information processing system according to (((6))), wherein the processor is configured to receive selection of a color for the colorization.
(((8)))

A program causing a computer to execute a process comprising:
in response to an automatic changing process performed in accordance with a preset rule on pixel data indicating a pixel in an overlapping portion of raster data created from a print job for forming an image by superposing, one on top of another, an object drawn with a normal toner and an object drawn with a special toner, displaying a value of attribute information that is subjected to the changing process in a format different from a format of a value of the attribute information that is not subjected to the changing process on a preview screen showing the raster data.

What is claimed is:

1. An information processing system comprising:
a processor configured to:
in response to an automatic changing process performed in accordance with a preset rule on pixel data indicating a pixel in an overlapping portion of raster data created from a print job for forming an image by superposing, one on top of another, an object drawn with a normal toner and an object drawn with a special toner different from the normal toner, display a value of attribute information that is subjected to the changing process in a format different from a format of a value of the attribute information that is not subjected to the changing process on a preview screen showing the raster data.

2. The information processing system according to claim 1, wherein the value of the attribute information that is subjected to the changing process comprises a first value and a second value.

3. The information processing system according to claim 2, wherein:
the changing process is a process of changing a density of the special toner in the overlapping portion to zero;
the first value is a value indicating an attribute of the object drawn with the special toner; and
the second value is a value indicating an attribute of the object drawn with the normal toner.

4. The information processing system according to claim 3, wherein the processor is configured to:
receive switching as to whether to display or hide the object drawn with the special toner on the preview screen;
when displaying the object drawn with the special toner, highlight a value indicating an attribute of the object drawn with the special toner as the value of the attribute information that is subjected to the changing process; and
when hiding the object drawn with the special toner, highlight a value indicating an attribute of the object drawn with the normal toner as the value of the attribute information that is subjected to the changing process.

5. The information processing system according to claim 1, wherein the processor is configured to, in response to the changing process performed on the pixel data in the overlapping portion, display a range of the overlapping portion between the object drawn with the normal toner and the object drawn with the special toner on the preview screen so that the range of the overlapping portion is discriminable from another portion.

6. The information processing system according to claim 5, wherein the processor is configured to display the range of the overlapping portion by colorization of the range of the overlapping portion so that the range of the overlapping portion is discriminable from the other portion.

7. The information processing system according to claim 6, wherein the processor is configured to receive selection of a color for the colorization.

8. A non-transitory computer readable medium storing a program causing a computer to execute a process comprising:
in response to an automatic changing process performed in accordance with a preset rule on pixel data indicating a pixel in an overlapping portion of raster data created from a print job for forming an image by superposing, one on top of another, an object drawn with a normal toner and an object drawn with a special toner, displaying a value of attribute information that is subjected to the changing process in a format different from a format of a value of the attribute information that is not subjected to the changing process on a preview screen showing the raster data.

9. An information processing method comprising:
in response to an automatic changing process performed in accordance with a preset rule on pixel data indicating a pixel in an overlapping portion of raster data created from a print job for forming an image by superposing, one on top of another, an object drawn with a normal toner and an object drawn with a special toner, displaying a value of attribute information that is subjected to the changing process in a format different from a format of a value of the attribute information that is not subjected to the changing process on a preview screen showing the raster data.
